(19) United States
(12) Patent Application Publication
(10) Pub. No.: US 2018/0020702 A1
(43) Pub. Date: Jan. 25, 2018

(54) METHOD AND DEVICE FOR THE BIOTECHNOLOGICAL REDUCTION OF SUGARS IN FRUIT EDUCTS FOR THE PURPOSE OF OBTAINING REDUCED-SUGAR FRUIT PRODUCTS

(71) Applicant: GUSTAV LERMER GMBH & CO KG, Freising (DE)

(72) Inventors: Thomas LOETZBEYER, Kranzberg (DE); Astrid JAEGER, Freising (DE); Rosina WESTERMEIER, Haag an der Amper (DE)

(73) Assignee: GUSTAV LERMER GMBH & CO KG, Freising (DE)

(21) Appl. No.: 15/552,114

(22) PCT Filed: Feb. 20, 2015
(86) PCT No.: PCT/DE2015/100071

§ 371 Date: Oct. 6, 2017

(51) Int. Cl. A23L 2/84; A23L 33/20; A23L 5/20; A23L 19/00; A23L 2/02; A23L 2/38

(52) U.S. Cl. CPC A23L 2/84; A23L 2/02; A23L 2/382; A23L 5/25; A23L 19/00; A23L 33/20; A23V 2002/00; C12Y 101/03004; C12Y 302/01026; C12Y 503/01018

(57) ABSTRACT

An inventive method and a device for the biotechnological reduction of sugar substances in fruit educts for the purpose of obtaining low-sugar fruit products characterized by enzymatic and/or fermentative reaction processes. Said method is characterized by a closed-loop control process, by means of which the pH value in the low-sugar fruit product is adjusted to a predetermined higher value, as compared to the pH value in the fruit educt, in such a way
that during the reduction of the sugar substances by at least 30% by weight to less than 40% by weight, the pH value is increased between 0.6 and 1.0 pH units; or
that during the reduction of the sugar substances by at least 40% by weight to less than 50% by weight, the pH value is increased between 0.7 and 1.1 pH units; or
that during the reduction of the sugar substances by at least 50% by weight to less than 65% by weight, the pH value is increased between 0.8 and 1.2 pH units; or
that during the reduction of the sugar substances by at least 65% by weight to less than 80% by weight, the pH value is increased between 0.9 and 1.3 pH units; or
that during the reduction of the sugar substances by at least 80% by weight, the pH value is increased between 1.0 and 1.4 pH units;
   wherein the aforementioned pH values may also turn out to be higher or lower by up to 0.1 or up to 0.2 pH units; and/or
   wherein, in the case of fermentatively formed sugar alcohols having a % by weight fraction of up to 3.0% by weight, the increase in the pH value with the simultaneous reduction of the sugar substances may turn out to be less by up to 0.3 pH units, as compared to a purely enzymatic process, wherein preferably both values correlate to each other, in particular, linearly.

The present invention can be used to obtain, in particular, low-sugar fruit products, such as fruit purées or fruit preparations or fruit powder or whole fruit beverages (smoothies) or fruit juices and/or vegetable juices (regardless of whether bottled undiluted as NFC juice or rediluted as fruit juice from fruit juice concentrate) or comparable fruit beverages that can be characterized as alcohol-free.

### FIELD OF THE INVENTION

The present invention relates to a method for the biotechnological reduction of sugar substances in fruit educts for the purpose of obtaining low-sugar fruit products, in particular, low-sugar, whole-fruit beverages or fruit juices and/or vegetable juices or comparable fruit beverages, which can be characterized as alcoholic free, as well as a device therefor.

### Definitions

As a precautionary measure to take into account any differentiation issues, at least the following terms are defined at the outset.

Thus, in the context of the present invention, the term “fruit” (English: “progeny”) refers to those edible parts of plants that, according to various definitions, are associated, on the one hand, with fruit (English: “fruit”) and, on the other hand, with vegetables (English: “vegetable”):
food definition: fruit comes from perennials; vegetables come from annuals.
botanical definition: fruit is the fruit developed from pollinated flowers; vegetables are other parts of plants (for example, leaf, root, tuber, etc.).

Usually the fruit comes from perennials and the vegetables from annuals (food definition). The sugar content of the fruit is usually higher. In botanical terms, fruit comes from the pollinated flower (for example: pineapple, apple, apricot, banana, pear, strawberry, grapefruit, raspberry, currant, cherry, kiwi, plum, orange, peach, plum, sour cherry, grape, lemon, plum [Prunus domestica], . . . ). Vegetables come from other parts of plants. Although cucumbers, pumpkins, peppers, tomatoes, and zucchini are fruit and belong, according to the above (botanical) definition, to fruit (pollinated flower), they are called vegetables (food definition: vegetables) as annuals and commonly due of the lack of sweetness and acidity. However, rhubarb is a petiole, but is also used as a fruit. Therefore, just from the aforesaid alone it becomes apparent that in the literature and in practice the distinction between fruit and vegetables is often blurred.

The term “fruit educt” is defined in the context of the present invention as those starting materials that consist of comminuted fruit. They may be, in particular, mashed, blended, or liquefied. In this case, parts of the fruit such as, in particular, the cell components may also be removed.

Furthermore, the term “low-sugar fruit products” is defined in the context of the present invention as those intermediate or finished products that have a sugar content that is reduced as compared to their natural fruit or fruit educts, in particular: fruit purées, fruit preparations or fruit powder, whole fruit beverages (smoothies) or fruit juices and/or vegetable juices (whether bottled undiluted as so-called NFC [Not From Concentrate] juice or diluted as so-called fruit juice from fruit concentrate) or comparable fruit beverages, which can be characterized as alcohol-free, wherein the latter product can be such beverages that usually contain 0.0 or, for example, according to German and Swiss food law, up to no more than 0.5 percent by volume of alcohol.

Finally, the term “sugar substances” is defined in the context of the present invention as the group of all carbohydrates that belong to the mono- and disaccharides, but also the longer-chained carbohydrates, which have a sweet taste. Some examples that can be mentioned include glucose, galactose, mannose, fructose, sucrose, lactose or maltose.

### BACKGROUND OF THE INVENTION

In particular, in view of the cariogenic effect and a significant increase in obesity and, associated therewith, also the cases of type II diabetes as early as in childhood, a multitude of attempts have already been made to reduce the amount of sugar consumed by children.

Against this background, the food industry is constantly looking for innovations. In particular, fruit products, such as whole fruit beverages (smoothies) or fruit juices and/or vegetable juices (whether bottled undiluted as NFC juice or rediluted as so-called fruit juice concentrate) or comparable fruit beverages, which can be characterized as alcohol-free, contain many health-related ingredients, but due to their typically high sugar content may lead to undesirable health impairments again, in particular, in children, if larger amounts are consumed on a regular basis.

Therefore, the natural amount of sugar substances in the dry mass, for example, in a pineapple is 82%; in an apple, 68%; in a strawberry, 55%; in a grapefruit, 67%; in a raspberry, 27%; in a currant, 37%; in an orange, 66%; in a sour cherry, 69%, or in a grape, 79%.

In this context, the sugar substances are composed primarily of sucrose, glucose, and fructose, wherein the percentage of their total mass (i.e., the mass of the ingredients per total mass in %; unit: [% w/w]) can vary widely depending on the fruit, as the following table shows.

| | Water content | Sucrose | Glucose | Fructose |
|---|---|---|---|---|
| Fruit | [% w/w] | [% w/w] | [% w/w] | [% w/w] |
| Pineapple | 85 | 7.8 | 2.1 | 2.4 |
| Apple | 85 | 2.6 | 1.7 | 5.9 |
| Strawberry | 90 | 1.0 | 2.2 | 2.3 |
| Grapefruit | 89 | 2.8 | 2.3 | 2.3 |
| Raspberry | 85 | 0.2 | 2.8 | 2.0 |
| Currant | 81 | 0.7 | 2.7 | 3.6 |
| Orange | 86 | 3.8 | 2.5 | 2.9 |
| Sour cherry | 84 | 0.5 | 4.8 | 5.8 |
| Grape | 81 | 0.4 | 7.3 | 7.3 |

As a result, the calories in fruit are determined almost exclusively by the sugar substances contained therein. Therefore, it would be desirable to significantly reduce the calories and additionally the cariogenic effect of fruit products by removing or converting the sugar substances in the fruit educts obtained from fruit.

Starting from the aforesaid, the prior art proposes complex methods for isolating the sugar substances by means of extraction or fermentation of sugar to alcohol and CO₂.

Thus, DE 2 214 442 A (=GB 1 373 562 B) discloses an enzymatic method for the conversion of glucose into gluconic acid by oxidation with oxygen in aqueous solution, wherein a glucose-containing aqueous solution is passed over a catalyst, which contains the glucose oxidase and the catalase bound together on a suitable substrate in the immediate vicinity; and wherein the pH value is maintained between 3.5 and 8.0 during the reaction.

Furthermore, EP 0 554 488 A1 discloses a fermentative method for the selective reduction of the sugar content of sugar-containing food, while retaining the original organoleptic properties, and a food product that is obtained accordingly, wherein the primary food is subjected to a controlled fermentation with a microorganism species, and wherein from various microorganism species suitable for the degradation of sugar the species that is the most suitable for the respective food is selected, based on a sensorial analysis in accordance with the ISO guideline 8587. Compared to the original starting material, the resulting food products have a reduced sugar content with figures for the remaining ingredients that are in the range of the natural fluctuation in the characteristic composition of the respective original food.

Moreover, U.S. Pat. No. 4,675,191 A (=AT 43 630 B) discloses a method for producing a low-alcohol content wine, wherein, unfermented grape juice is first treated by feeding oxygen to the grape juice with a glucose oxidase preparation, until at least a smaller quantity of the glucose is converted into gluconic acid, whereupon the so-treated, low-glucose content grape juice is fermented to produce the low-alcohol content wine, wherein—if desired—the gluconic acid is removed at least partially until suitable organoleptic properties are attained.

Furthermore, WO 2005/074716 A1 (=EP 1 713 351 B1) discloses a method for producing a food product by heat treatment of a food material containing reducing sugars, said method comprising the step of blanching the food material, wherein the blanching step includes subjecting the food product to an active blanching medium under blanching conditions in a blanching section, in order to produce a spent blanching medium, withdrawing the reducing sugars and/or asparagine from the spent blanching medium, in order to produce an active blanching medium using a sugar and/or asparagine withdrawing medium and reusing the active blanching mediums, under the condition that in the event that only one of the reducing sugars and asparagines is withdrawn from the spent blanching medium and said food product is potato slices, then the said reducing sugars or asparagines are not withdrawn using a column containing immobilized enzymes, wherein the outflow from the column is fed back to the potato slices.

Finally, reference should also be made to U.S. Pat. No. 3,362,836 A, which discloses a method for producing albumen (endosperm, protein).

In addition, the existing methods for obtaining low-sugar fruit products are generally restricted to the dilution of the sugar substances with water. However, such a method also reduces the concentration of the physiologically important secondary ingredients (in particular, polyphenols, vitamins, etc.), which are naturally contained in the fruit or fruit educts obtained therefrom. In addition, the resulting shift in the flavor is balanced in the fruit products, which have been developed to date, increasingly by using undesirable flavorings and dyes that cannot, of course, meet the steadily growing desire of consumers for food with natural ingredients.

The fundamental problem that is inherent in the past application of the prior art is the formation of low-sugar fruit products, which to date do not lead to low-sugar fruit products that are acceptable to the sense of taste because of the unbalanced ratio between acids and sugar substances resulting from the lack of sugar contained in the low-sugar fruit product, where in the context of the present invention said acid-to-sugar ratio is called in brief the “sugar/acid ratio”.

### Object of the Invention

Based on the aforesaid, the object of the present invention is to provide a method for the biotechnological reduction of sugar substances in fruit educts for the purpose of obtaining low-sugar fruit products, wherein said method preserves both the physiologically important secondary ingredients contained in the fruit educts and at the same time significantly reduces the often undesirably high sugar content and maintains balanced flavors without the use of undesirable flavorings and dyes. In order to prevent the destruction of or damage to the healthy natural ingredients of the fruit educts (in particular, polyphenols, vitamins, acids), the objective is to use, in particular, for the intended reduction of sugar substances in fruit educts, only those methods that can run at temperatures that do not damage the product, and which also do not require extreme pH values (in particular, not greater than a pH of 6 and not less than a pH of 3) or the addition of organic solvents or the addition of sweeteners.

### Solution of the Invention

This object is achieved by a method and a device for the biotechnological reduction of sugar substances in fruit educts for the purpose of obtaining low-sugar fruit products exhibiting the features disclosed in the independent patent claims.

The inventive method for the biotechnological reduction of sugar substances in fruit educts for the purpose of obtaining low-sugar fruit products is characterized by enzymatic and/or fermentative reaction processes. The method is characterized by a closed-loop control process, by means of which the pH value in the low-sugar fruit product is adjusted to a predetermined higher value, as compared to the pH value in the fruit educt, in such a way
that during the reduction of the sugar substances by at least 30% by weight to less than 40% by weight, the pH value is increased from 0.6 to 1.0 pH units; or
that during the reduction of the sugar substances by at least 40% by weight to less than 50% by weight, the pH value is increased from 0.7 to 1.1 pH units; or
that during the reduction of the sugar substances by at least 50% by weight to less than 65% by weight, the pH value is increased from 0.8 to 1.2 pH units; or
that during the reduction of the sugar substances by at least 65% by weight to less than 80% by weight, the pH value is increased from 0.9 to 1.3 pH units; or
that during the reduction of the sugar substances by at least 80% by weight, the pH value is increased from 1.0 to 1.4 pH units;
   wherein the aforementioned pH values may also turn out to be higher or lower by up to 0.1 or up to 0.2 pH units; and/or
   wherein, in the case of fermentatively formed sugar alcohols having a % by weight fraction of up to 3.0% by weight, the increase in the pH value with the simultaneous reduction of the sugar substances may turn out to be less by up to 0.3 pH units, as compared to a purely enzymatic process.

The adjustment proposed by the invention of a higher pH in the low-sugar fruit product with respect to the pH in the fruit educt by at least 0.1 pH units in the case of fermentatively formed sugar alcohols or in any other case by at least 0.4 pH units has the advantage of preventing a bitter taste and, in particular, irrespective of whether enzymatic and/or fermentative reaction processes were used as an alternative or in addition. Instead, for the first time, it was possible to obtain a low-sugar fruit product having an acid/sugar ratio that is balanced with respect to the sense of taste, i.e. having a balanced ratio between sour and sweet flavors without having to otherwise add the conventional undesired flavorings and colorants.

### PREFERRED EMBODIMENTS OF THE INVENTION

Advantageous embodiments and further developments, which can be used individually or in combination, are the subject matter of the dependent claims.

Therefore, it is particularly preferred that in the case of fermentatively formed sugar alcohols, the resulting low pH value correlates linearly to the % by weight fraction of the sugar alcohols in such a way that, for example,
at 1.0% by weight of fermentatively formed sugar alcohols, the pH value increase turns out to be less by 0.1 pH units, and
at 2.0% by weight of fermentatively formed sugar alcohols, the pH value increase turns out to be less by 0.2 pH units, and
at 3.0% by weight of fermentatively formed sugar alcohols, the pH value increase turns out to be less by 0.3 pH units,
   a feature that advantageously simplifies the design of the closed-loop control process in conjunction with the combined reaction processes.

A preferred embodiment of the method according to the invention is characterized by an enzymatic conversion of sucrose into glucose and fructose by means of invertase and/or by an enzymatic conversion of fructose into glucose by means of glucose isomerase.

Sucrose, also known as household or granulated sugar, is composed of an α-D-glucose and a β-D-fructose molecule, linked to one another by means of an α, β-(1-2)-glycosidic bond. In the presence of water, which, in addition to the sugar substances, constitutes the main ingredient in fruit or the resulting fruit educts, the sucrose in this embodiment can be split advantageously into a fructose (fruit sugar) and a glucose (grape sugar) molecule with the aid of the enzyme invertase (β-D-fructofuranosidase). The reaction scheme of this hydrolysis of sucrose into glucose and fructose by means of invertase can be represented as follows:

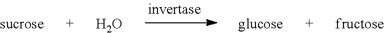

In this way, it is possible to use the enzyme invertase to convert, if desired also completely, the sucrose present in the fruit educt into glucose and fructose, and to use enzymatic and/or fermentative reaction processes in an advantageous way to further convert and/or degrade said sucrose.

Owing to the alternative or additional use of the enzyme glucose isomerase, the fructose in the fruit educt can be advantageously converted into glucose and can be degraded and/or further converted by enzymatic and/or fermentative reaction processes.

Another preferred embodiment of the method according to the invention is characterized by an enzymatic degradation of glucose, which may or may not be formed by means of invertase and/or glucose isomerase and/or is already present in the fruit educt, by means of the enzyme glucose oxidase to form gluconic acid. However, it also produces hydrogen peroxide (H₂O₂) as an unwanted by-product. This hydrogen peroxide can destroy important secondary plant ingredients in the fruit educt due to its strong oxidative effect.

In order to avoid this situation, it is preferred that the enzyme catalase be used simultaneously, which converts the resulting hydrogen peroxide into harmless water and oxygen. The reaction scheme of the glucose oxidase/catalase enzyme system can be represented as follows:

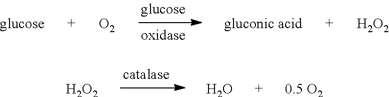

Because the simultaneous use of the combination of enzymes glucose oxidase and catalase with the reaction of a glucose molecule allows half of an oxygen molecule to be removed from the fruit educt, the glucose degradation also leads advantageously to a removal of the oxygen and, thus, to the protection of particularly oxidation-sensitive vitamins and polyphenols in the fruit educt.

However, during degradation of the aforementioned sugar substance in the fruit educt, the above described enzymatic reactions of glucose oxidase and catalase can terminate very quickly due to a rapid drop in the pH value and the consequent inactivation of the enzymes used. Then, the reaction for forming the gluconic acid would run uneconomically slowly due to the rapid consumption of the amounts of oxygen present in the starting material.

Therefore, it is preferred, according to a further development of the method, to supply the oxygen required to break down the glucose during the enzymatic reactions by means of glucose oxidase and catalase. In particular, it is preferred that, during the enzymatic reaction processes by means of glucose oxidase and catalase, the oxygen supply be adjusted to saturation levels between 5% and 60%, preferably between 10% and 40%, even more preferably between 30% and less than 40%. An undesired oxidation of nutritionally valuable ingredients in the fruit educt could be ensured, especially if the oxygen content was adjusted to preferably less than 40%. In the oxygen required solely for the degradation of the sugar substance glucose for the viability and reactivity of enzymes, there is provided advantageously a method, which can be carried out at an economical process rate and which is intended for the biotechnological reduction or even elimination of the sugar substance glucose at any level or even at 100% of its original natural amount and optionally also enzymatically converted amounts, but, in particular, for a commercially interesting glucose degradation with a respective caloric reduction of at least 30% in fruit educts for the purpose of obtaining low-sugar fruit products.

It is expedient to blow oxygen uniformly into a device designed for carrying out the method, a feature that offers the advantage of maintaining the targeted saturation values at a constant level.

As an alternative or in addition to enzymatic reaction processes, in particular, by means of glucose oxidase and catalase, a further development of the method that is preferred according to the invention is characterized by a fermentative degradation of fructose and/or glucose to form sweetening sugar alcohols by means of special microorganisms, such as Leuconostoc mesenteroides, Monitiella tomentosa, and Candida magnoliae. The fermentative method may be carried out under aerobic conditions or preferably under anaerobic conditions, but then not at the same time as a regulated supply of oxygen.

In accordance with the present invention, preferably such microorganisms are used which—in spite of a low pH and hardly any available nitrogen sources (which is normally the basis for the growth of microorganisms)—grow in the fruit educt and in the presence of the fruit's own bactericides (such as, for example, polyphenols), in particular, fungi, yeasts, and/or bacteria.

In this respect, positive experiences were gained, for example, with the lactic acid bacterium Leuconostoc mesenteroides. However, it forms the laxative-acting mannitol as a sugar alcohol.

Therefore, particularly preferred are microorganisms that form laxative-free, i.e. not laxative-acting, sweetening sugar alcohols, such as, in particular, erythritol. In this respect, positive experiences were gained, for example, with the fungus Monitiella tomentosa or with the yeast Candida magnoliae.

The use of fungi, yeasts, and/or bacteria has an advantageous effect that of any arbitrary amount of sugar (=100%), already about half (=50%) is “consumed” by the microorganisms; and the other 50% is converted into sweetening, low-calorie compounds at a ratio of about 2:1, a figure that, based on the amount of sugar (100%) used, has the advantage of effectively reducing by 75% the sugar and calories from originally 100% to 25% in the targeted fruit product.

A method for the anaerobic fermentation, in particular, as a further development of the method of the invention, is characterized by the fact that before and/or during the use of anaerobic microorganisms, the removal of oxygen is carried out completely enzymatically by means of the reaction processes: glucose oxidase and catalase reactions.

The complete removal of oxygen by means of the aforementioned enzymatic reaction processes (glucose oxidase and catalase reactions) enables in an advantageous way the production of anaerobic reaction conditions without a lot of equipment and expense, as has been the case to date in the prior art with respect to growing microorganisms that break down fructose and/or glucose and form sweet, non-cariogenic, and low-calorie sugar alcohols.

In a further development of the present invention, the adjustment to a higher pH value is carried out preferably in an automated manner during the reaction processes.

The adjustment, preferably the automated adjustment, to a higher pH value as early as during the reaction processes has the advantage of speeding up the reaction processes over time and, in so doing, results in a higher efficiency, because the enzymes and the microorganisms that are used according to the invention respond faster at more neutral or less acidic pH values, but, in particular, at higher pH values than those that are found in the fruit educt.

However, it is important not to adjust the pH value in the fruit educts or fruit products to greater than 6.0 before, during, and after the biotechnological reaction, since above this pH value there may be irreversible destruction of nutritionally important secondary plant ingredients, such as polyphenols, anthocyanins, or also natural flavorings.

According to the invention, the adjustment to a higher pH value is carried out preferably by adding tasteless salts and/or salt suspensions, such as, in particular, magnesium oxide and/or magnesium oxide suspension.

The aforementioned magnesium compounds have the advantage that they are significantly better tasting than potassium, calcium, or sodium compounds that are also conceivable: sodium compounds taste salty; potassium and calcium compounds taste bitter.

The present invention also relates to a device for carrying out a method, as described above, the device being characterized by the fact that at least
means for the uniform introduction of oxygen up to a content that is compatible with sensitive secondary ingredients in the fruit educt, and/or
means for adjusting a pH value by metering in an acidity regulator to a higher value, as compared to the pH value in the fruit educt;
   are provided in this device.

In one embodiment of the device for carrying out the method according to the invention, said device is designed so as to be preferably closed and to work preferably at room temperature.

In this case, a device that is designed so as to be preferably closed during the enzymatic reaction processes has the advantage of preventing losses (volatilization) of the added oxygen and flavors in the fruit educt and ensuring that the anaerobic conditions are maintained during (temporally downstream anaerobic) fermentative reaction processes.

Similarly, a device for carrying out the method according to the invention can be acquired at a relatively low cost, if both the enzymatic and the fermentative reaction processes are carried out preferably at temperatures that do not damage the product, in particular, at room temperature.

The present invention can be used to obtain, in particular, low-sugar fruit products, such as fruit purées or fruit preparations or fruit powder or whole fruit beverages (smoothies) or fruit juices and/or vegetable juices (regardless of whether bottled undiluted as NFC juice or rediluted as fruit juice from fruit juice concentrate) or comparable fruit beverages that can be characterized as alcohol-free, wherein the pH value in the low-sugar fruit product is adjusted, according to the invention, to a predetermined higher value, as compared to the pH value in the fruit educt.

The production of low-sugar fruit products by means of the biotechnological methods presented herein offers an opportunity to enter the market with innovative fruit products having a unique selling point. Currently, there is no fruit product that contains, on the one hand, the healthy natural ingredients found in fruit and at the same time has a very low sugar content and also has an acid/sugar ratio that is balanced in terms of the sense of taste.

### BRIEF DESCRIPTION OF THE DRAWINGS

Additional details and other advantages of the invention are described below with reference to preferred exemplary embodiments that are documented by means of laboratory experiments (hereinafter abbreviated as AB), but to which the present invention is not limited, and in conjunction with the accompanying drawings.

The drawings show in schematic form

FIG. 1 in a process diagram the basic steps of the inventive method for the biotechnological reduction of sugar substances in fruit educts for the purpose of obtaining low-sugar fruit products by means of enzymatic and/or fermentative reaction processes;

FIG. 2 a reaction scheme of enzymatic reaction processes;

FIG. 3 a profile of an adjusted pH value at 4.3;

FIG. 4 an adjusted oxygen saturation at an average 30% oxygen O₂;

FIG. 5 a curve over time of the degradation of glucose in a grape juice by means of glucose oxidase;

FIG. 6 removal of the sugar substance sucrose in an orange juice by means of the enzyme invertase;

FIG. 7 a comparison of the sugar content of various NFC juices before and after an enzymatic breakdown of the sugar;

FIG. 8 the dependence of a balanced acid/sugar ratio of various fruit juices after an enzymatic sugar reduction of the pH value;

FIG. 9 a reaction scheme of fermentative reaction processes;

FIG. 10 a fermentative reduction of the sugar substances glucose (left) and fructose (right) by means of the fungus Monitiella tomentosa to form erythritol;

FIG. 11 a reaction scheme of the combined enzymatic and fermentative reaction processes with a fermentative focus;

FIG. 12 a reaction scheme of the combination of all of the above described enzymatic and fermentative reaction processes with any selectable focus;

FIG. 13 laboratory equipment setup;

FIG. 14 oxygen saturation in the course of an enzymatic degradation of the sugar substances sucrose and glucose in an NFC pineapple juice;

FIG. 15 a pH profile during the enzymatic degradation of the sugar substances sucrose and glucose in an NFC pineapple juice; and

FIG. 16 the basic change in the concentration of the sugar substances (sucrose and glucose) during the enzymatic degradation and the formation of sugar alcohol during the fermentative degradation of fructose in an NFC pineapple juice.

### DETAILED DESCRIPTION OF THE FIGURES

Sugar substances form, in addition to water, the most important ingredients of fruit. In this context, the sugar substances are composed primarily of sucrose, glucose, and fructose together, where the percentage of their total mass can vary widely depending on the fruit (see the system shown in the introductory part of the specification).

The overwhelming majority of these sugar substances may be found again in the fruit products that are produced from fruit educts. For example, a study of various commercially available NFC juices, where the NFC juices include such fruit juices and/or vegetable juices that are bottled immediately after the juice has been freshly squeezed without the addition of additional sugar and contain only the sugar substances from the respective fruit educt, gives the following typical sugar contents:

| | Sucrose | Glucose | Fructose |
|---|---|---|---|
| NFC juice | [g/L] | [g/L] | [g/L] |
| Pineapple juice | 41.7 | 32.4 | 35.8 |
| Grapefruit | 14.4 | 35.4 | 39.4 |
| Orange juice | 31.7 | 27.8 | 32.3 |
| Grape juice | n.n. | 86.8 | 87.6 |

It turns out that, in particular, the grape juices have high levels of glucose and fructose. However, sucrose is found in a higher concentration in primarily pineapple juice and orange juice.

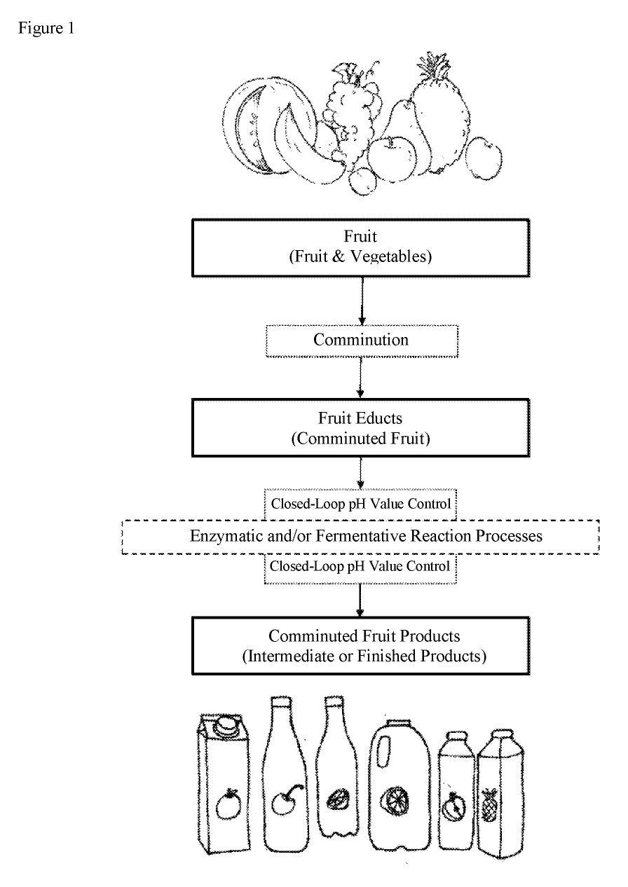

FIG. 1 illustrates with reference to a schematic process diagram the basic steps of an inventive method for the biotechnological reduction of sugar substances in fruit educts for the purpose of obtaining low-sugar fruit products by means of enzymatic and/or fermentative reaction processes. As shown in FIG. 1, the inventive method is characterized by a control process, by means of which the pH value in the low-sugar fruit product is adjusted to a predetermined higher value as compared to the pH value in the fruit educt. The adjustment, provided according to the invention, of the pH value in the low-sugar fruit product to a predetermined higher value as compared to the pH value in the fruit educt has the advantage of preventing a bitter taste in the low-sugar fruit product and, in particular, regardless of whether enzymatic and/or fermentative reaction processes were used as an alternative or in addition.

### AB 1: Establishing the Enzymatic Process for Removing Glucose, Sucrose, and/or Fructose

Due to the high caloric value and the cariogenic effect of the sugar substances glucose, sucrose, and/or fructose, it is possible to provide, according to the present invention, enzymatic reaction processes, by means of which sucrose, fructose and/or, in particular, glucose in the fruit or fruit educts is/are broken down enzymatically.

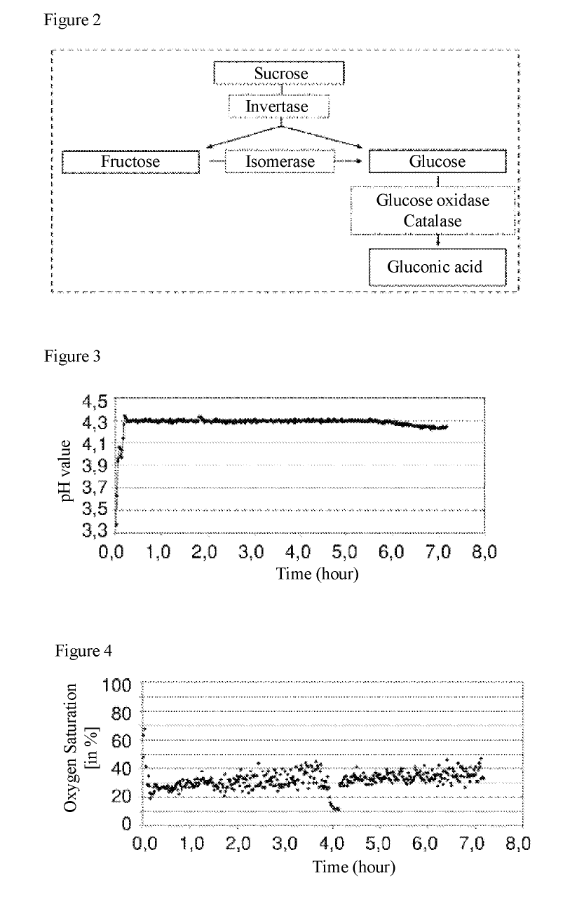

FIG. 2 shows a reaction scheme of enzymatic reaction processes. It can be seen how a combination of the enzymes invertase, glucose oxidase, and catalase is used to remove not only the sugar substance sucrose that is present in fruit educts, but also the sugar substance glucose that is formed at the same time. The enzyme isomerase can also be used to convert the sugar substance fructose into glucose and to break it down enzymatically.

### AB 1.1: Glucose Degradation by Means of Glucose Oxidase

At the same time, it was possible to counteract the uneconomically slow reaction processes with a closed loop control process for the closed-loop control of the pH value even during the reaction processes and/or with a closed-loop control process for feeding in the needed oxygen, wherein the oxygen was blown preferably uniformly into a device for carrying out the method, and, in so doing, the supply of oxygen was adjusted preferably to oxygen saturation levels between 5% and 60%, in particular, between 10% and 40%, even more preferably between 30% and less than 40%.

FIG. 3 shows the profile of the pH value of a, preferably automatic, closed-loop control during the reaction processes at a pH of 4.3, as an example. It can be seen how the preferred automatic closed-loop control of the pH holds the pH value reliably in a range of +/−0.05 pH units during the reaction processes.

FIG. 4 shows the automatically adjusted oxygen saturation in an NFC juice, for example, to an average 30% oxygen O₂. Due to the high sensitivity of the oxygen electrode and the gas bubbles in the fruit educt, it is possible to observe here short-term fluctuations in the oxygen content of the solution, but a negative impact on the quality of the low-sugar fruit product could not be determined.

FIG. 5 shows the curve over time of the degradation of glucose in a grape juice by means of glucose oxidase. It gives impressive proof of how it was possible with the closed-loop control processes, described above (closed-loop control 4.3 pH, 30% oxygen), to break down completely the glucose of a grape juice by means of the enzymes glucose oxidase and catalase in just 7 hours. Analogous experiments with raspberry juice, cherry juice, orange juice, pineapple juice, and grapefruit juice led to comparable results and show the universal applicability and efficiency of the developed method to the most relevant fruit matrices.

### AB 1.2: Sucrose Removal by Means of Invertase

Even the sugar substance sucrose can be found, with the exception of the grape, in most types of fruit and to some extent at a significant percentage. Therefore, in addition to the degradation of glucose, an additional method for also removing this sugar substance is provided. In particular, it is proposed that the sucrose be split equally into glucose and fructose by means of the enzyme invertase (sucrose). Because the commercially available sucrose (invertase), which was used in various experiments, has a very high enzyme activity, said invertase was amazingly able to break down a sucrose content of about 24 g/L (orange juice) in an orange juice completely into glucose and fructose within only 2 hours.

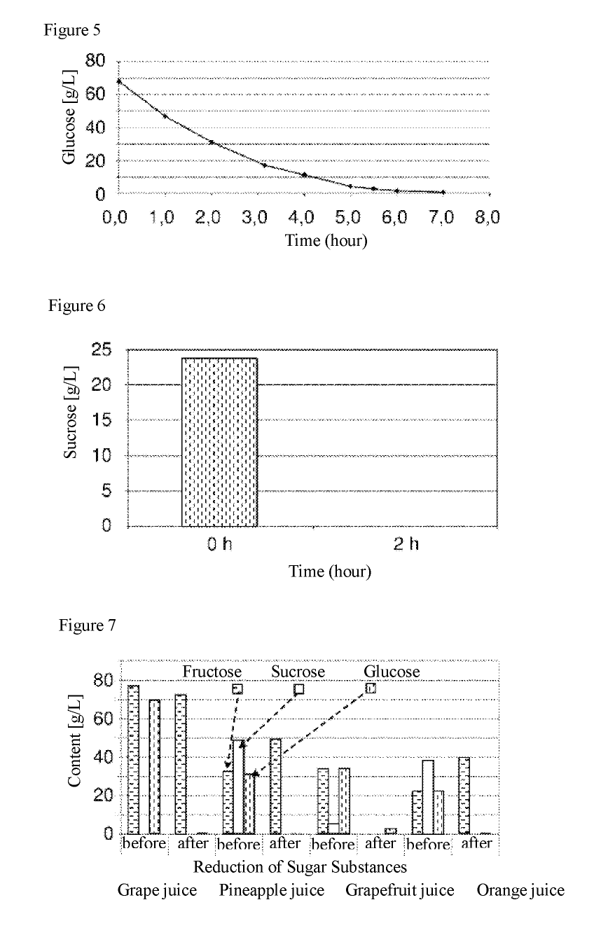

FIG. 6 shows the removal of the sugar substance sucrose in an orange juice by means of the enzyme invertase, primarily at room temperature, in particular, between 20 deg. C. and 30 deg. C., and at a pH value of 4.3 adjusted during the reaction processes.

### AB 1.3: Degradation of Glucose and Sucrose in the Fruit Matrix

In the experiments described below, it was also possible to examine the advantageous possibilities and effects of a combination of the three enzymatic reactions that are shown and that are provided for the complete removal of, in particular, the sugar substances sucrose and glucose from the fruit educt matrix.

For this purpose, various fruit juices were added to a mixture of the three enzymes invertase, glucose oxidase, and catalase; and then, before and after the end of the enzymatic degradation (within 7 hours), the sugar levels were quantified during the reaction processes while simultaneously adjusting to a predetermined higher pH value, as compared to the pH value in the fruit educt, while simultaneously adjusting the oxygen content in the assembled reactor.

FIG. 7 shows a comparison of the sugar content of various NFC juices before and after an enzymatic breakdown of the sugar. The results with different NFC juices are impressive insofar as according to these results it was possible to completely remove the sugar substances glucose and sucrose with enzymes in the fruit educt matrix within 7 hours, even in a grape juice with a glucose content of about 70 g/L.

### AB 1.4: Fructose Removal by Means of Glucose Isomerase

The above results alone clearly demonstrate the effectiveness of the developed enzymatic reaction processes in a method for the complete removal of the sugar substances glucose and sucrose from various fruit educt matrices. These reaction processes can be expanded, depending on the respective requirement, to include glucose isomerase, which was shown in the introduction, for the conversion of fructose.

In this respect, it should be noted that glucose isomerase usually comes to an equilibrium at a ratio of 1:1 (glucose content:fructose content), for which reason, according to the invention, only the additional use of glucose oxidase prefers a removal of glucose from this equilibrium, and, in so doing, enables a complete degradation of fructose by means of glucose (glucose isomerase) into gluconic acid (glucose oxidase).

### AB 1.5: Dependence of the Balanced Acid/Sugar Ratios

Furthermore, it was found surprisingly that the adjustment of a pH value, not only during enzymatic and/or fermentative (more on that later) reaction processes but also in the low-sugar fruit product itself to a predetermined higher value as compared to the pH value in the fruit educt in such a way
that during the reduction of the sugar substances by at least 30% by weight to less than 40% by weight, the pH value is increased from 0.6 to 1.0 pH units; or
that during the reduction of the sugar substances by at least 40% by weight to less than 50% by weight, the pH value is increased from 0.7 to 1.1 pH units; or
that during the reduction of the sugar substances by at least 50% by weight to less than 65% by weight, the pH value is increased from 0.8 to 1.2 pH units; or
that during the reduction of the sugar substances by at least 65% by weight to less than 80% by weight, the pH value is increased from 0.9 to 1.3 pH units; or
that during the reduction of the sugar substances by at least 80% by weight, the pH value is increased from 1.0 to 1.4 pH units;
   has the advantage of preventing the bitter taste and, in particular, regardless of whether enzymatic and/or fermentative (more on that later) reaction processes were used as an alternative or in addition,
   wherein the aforementioned pH values may also turn out to be higher or lower by up to 0.1 or up to 0.2 pH units; and/or
   wherein, in the case of fermentatively formed sugar alcohols having a % by weight fraction of up to 3.0% by weight, the increase in the pH value with the simultaneous reduction in the sugar substances may turn out to be less by up to 0.3 pH units, compared to a purely enzymatic process, wherein preferably both values correlate to each other, in particular, linearly.

Hence, for the first time, a low-sugar fruit product having a balanced “acid/sugar ratio” that is balanced in terms of the sense of taste, i.e. having a balanced ratio between sour and sweet flavors, was obtained without having to otherwise add the conventional undesired flavorings and colorants.

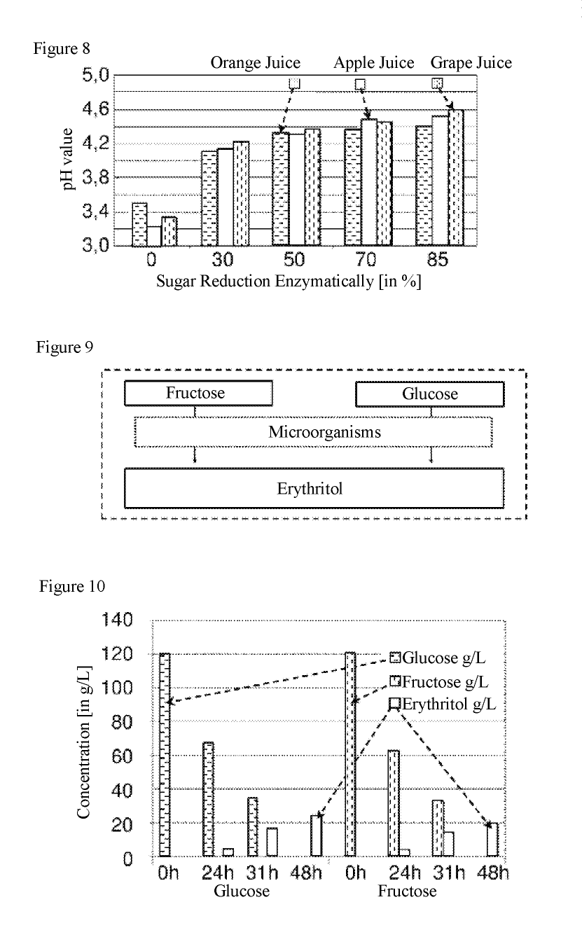

FIG. 8 shows the average dependence of a balanced acid/sugar ratio of various fruit juices after an enzymatic sugar reduction of the pH value. According thereto, it was possible to obtain good results in enzymatic reaction processes in terms of both taste as well as process when the pH value is increased by about 0.8 pH units during a targeted reduction of the sugar substances by at least 30% by weight to less than 40% by weight; when the pH value is increased by about 0.9 pH units (not shown) during a targeted reduction of the sugar substances by at least 40% by weight to less than 50% by weight; when the pH value is increased by about 1.0 pH units during a targeted reduction of the sugar substances from at least 50% by weight to less than 65% by weight; when the pH value is increased by about 1.1 pH units during a targeted reduction of the sugar substances from at least 65% by weight to less than 80% by weight (shown are the values at 70% by weight %); and when the pH value is increased by about 1.2 pH units during a targeted sugar reduction by at least 80% by weight (shown are the values at 85% by wt. %); wherein in the individual case these values turned out to be higher or lower by even 0.1 to 0.2 pH units.

### AB 2: Establishing a Fermentative Method for the Removal of the Sugar Substances Fructose and/or Glucose to Form Sugar Alcohols

Following completion of the degradation of the sugar substances sucrose and glucose, only the fructose remains in most fruit educts as the relevant sugar substance. While according to the invention a conversion of fructose into glucose is also possible, preferably with the enzyme glucose isomerase, it is also possible to not use an enzymatic method in order to break down the fructose, but rather to use a microorganism-based fermentation method, which advantageously takes into account gustatory aspects in the low-sugar fruit product through the formation of desired sweetening compounds.

In this respect, the present invention provides that preferably such microorganisms are used that in spite of a low pH value and hardly any nitrogen sources (where said nitrogen is usually the basis for the growth of microorganisms) grow in the fruit educt and in the presence of the fruit's own bacteriocides (such as, for example, polyphenols), in particular, fungi, yeasts and/or bacteria.

Positive experiences were gained, for example, with the lactic acid bacterium Leuconostoc mesenteroides. However, it forms laxative-acting mannitol as a sugar alcohol. At amounts of up to 45 g/L of mannitol formed in this way and at average consumption levels of 0.5 L of fruit drink, the low-sugar fruit beverages of the method developed according to the invention may have a slightly laxative effect in sensitive individuals.

Therefore, preference was given below to microorganisms that are, in fact, able to break down the sugar substance fructose, which does not produce any potentially problematic products, such as alcohol or mannitol, during the degradation of fructose, but rather forms laxative-free, i.e. non-laxative-acting, sweetening sugar alcohols, such as, in particular, erythritol.

FIG. 9 shows a reaction scheme of fermentative reaction processes. It shows the way in which the degradation of the sugar substances fructose and/or glucose can be carried out by means of microorganisms with simultaneous formation of erythritol.

In this respect, positive experiences were gained, for example with the fungus Monitiella tomentosa or with the yeast Candida magnoliae.

FIG. 10 shows the fermentative reduction of the sugar substances glucose (left) and fructose (right) by means of the fungus Monitiella tomentosa to form erythritol. It can be seen that after 24 hours the sugar alcohol erythritol is just beginning to form, but after 48 hours the sugar substances have been completely broken down.

In this case, the use of the fungus Monitiella tomentosa has an advantageous effect that of any arbitrary amount of sugar substances (=100%), already about half (=50%) is “consumed” by the microorganisms; and the other 50% is converted into sweetening, low-calorie compounds at a ratio of about 2:1, a figure that, based on the amount of sugar substances (100%) used, has the advantage of effectively reducing by 75% the sugar substance and/or calories from originally 100% to 25% in the targeted fruit product.

Just as in the case of purely enzymatic reaction processes (see above), so, too, in the case of the fermentative reaction process, the pH value in the low-sugar fruit product was adjusted to a predetermined higher value, as compared to the pH value in the fruit educt, in order to achieve a balanced acid-to-sugar ratio, an aspect that is a prerequisite for the consumer's acceptance of the taste.

Owing to the formation of sweet-tasting compounds, such as erythritol, but with simultaneous formation of sugar substances, as compared to a purely enzymatic reaction process in the case of fermentatively sugar alcohols having a % by weight fraction of up to 3.0% by weight, the inventive pH increase could turn out to be less by up to 0.3 pH units, wherein preferably both values correlate to each other, in particular, linearly.

The dependence of a balanced acid-to-sugar ratio on the pH value during the fermentative reduction of the sugar and the production of erythritol, for example in apple juice, is also illustrated with reference to the table below:

| Sugar | Erythritol | pH balanced |
|---|---|---|
| reduction in % | content in % | sugar/acid ratio |
| 30 | 0.7 | 3.9 |
| 50 | 1.4 | 4.2 |
| 70 | 1.8 | 4.3 |
| 85 | 2.2 | 4.5 |

### AB 3: Combination of Enzymatic and Fermentation Processes

The inventive method for the biotechnological reduction of sugar substances in fruit educts for the purpose of obtaining low-sugar fruit products will also win distinction in the field due to the combination of enzymatic and fermentative reaction processes. Such combination methods make a kind of modular or platform technology available that can be used in many foods to remove all relevant fractions of sugar substances by means of biotechnological processes.

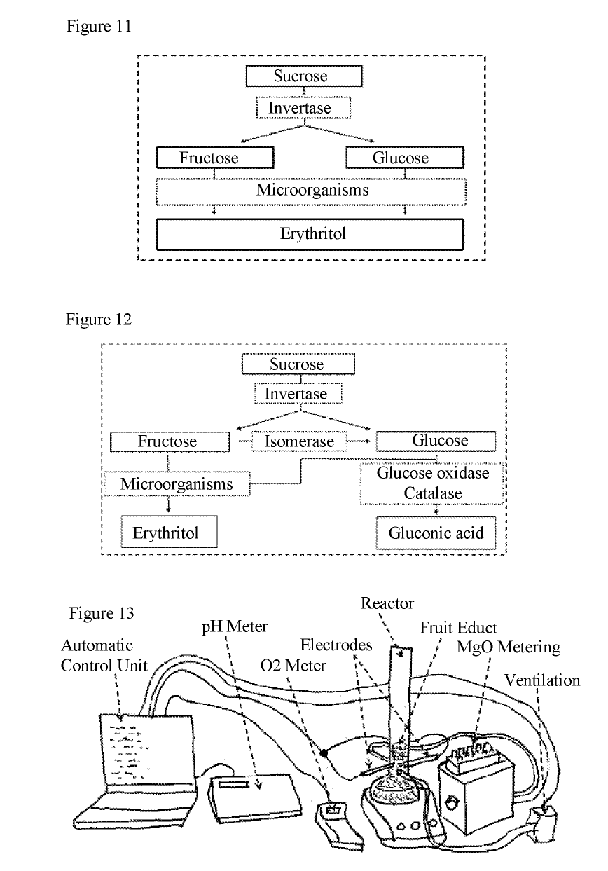

FIG. 11 shows an example of a reaction scheme of the combined enzymatic and fermentative reaction processes with a fermentative focus. It shows the degradation of the sugar substances fructose and/or glucose by means of microorganisms with simultaneous formation of erythritol and the optional removal of the sugar substance sucrose through the use of the enzyme invertase.

FIG. 12 shows an example of a reaction scheme of the combination of all enzymatic and fermentative reaction processes described above with any selectable (enzymatic and/or fermentative) focal points. These methods can be used to break down enzymatically and/or fermentatively all of the sugar substances contained in fruit educts (such as, in particular, sucrose, fructose, and/or glucose) in combined reaction processes; and yet, at the same time, it is still possible to retain the sweetening substances in the low-sugar fruit product in an advantageous way. In addition, low calorie, sweet-tasting compounds, such as, in particular, erythritol, can be formed in a fermentation step.

### AB 4: Equipment Setup and Process Control

FIG. 13 shows, with reference to a laboratory setup of the equipment, one example of the way in which a sophisticated yet inexpensive measuring and control technology is advantageous in both the enzymatic and any fermentative reaction processes to ensure a repeatable and reliable process flow, which is carried out preferably in a batch mode. It shows the way in which the reactor technology required for a single process as well as a combination of processes can manage not only with the sensors that are used (pH and 0₂ electrodes), but also with preferably automatic, open and closed-loop control technology without having to resort to expensive or sophisticated equipment.

For example, ventilation by means of a simple frit for the introduction of the oxygen required for the breakdown of glucose into gluconic acid into a device (reactor) may be sufficient for carrying out the method. As an alternative or in addition thereto, means for injecting oxygen into the device may be provided for carrying out the method.

In order to adjust the pH, preferably magnesium oxide (MgO) and/or magnesium oxide suspensions are used as an acidity regulator, since advantageously they do not have an adverse effect on the taste of the targeted low-sugar fruit products.

The illustrated laboratory equipment for carrying out a method according to the invention comprises, for example, a 3-liter reactor equipped with a pH electrode, an oxygen electrode, and a frit for ventilating with pure oxygen. Of course, the 20% fraction of oxygen in air can also be used, except that in this case the speed of the process decreases accordingly. Preferably, the fruit educts in the reactor are stirred by means of a magnetic or comparable stirrer during the reaction processes in order to ensure a uniform distribution of the oxygen and the MgO. Magnesium oxide (MgO) is sparingly soluble and is, therefore, added preferably as a 10% suspension, for example by means of a peristaltic pump. During the reaction processes, the pH value and the oxygen saturation can be automatically adjusted by means of an automatic control unit, for example, a computer-controlled closed-loop control system.

After the oxygen has been consumed by means of glucose oxidase in the enzymatic reaction process and the pH value has dropped due to the gluconic acid that is formed, the oxygen supply is controlled, for example, by means of a valve; and the metering of the acidity regulator magnesium oxide is controlled, for example, by means of a pump. The oxygen control is carried out preferably by means of an O₂ meter, the pH control preferably by means of a pH meter.

The latter is also advantageous in the fermentation step following the enzymatic reaction process, since a drop in the pH value is also associated with the fructose degradation, in particular, in the case of lactic acid bacteria; and this drop in the pH value can be counteracted by the addition of, for example, sodium hydroxide (NaOH). Insofar as the fermentative step runs anaerobically, it is not necessary (is no longer necessary) to add oxygen.

Irrespective of the extent to which a pH value control is used even during the enzymatic and/or fermentative reaction processes in the fruit educt, in particular, from the viewpoint of speeding up the process, the inventive closed-loop control process for the pH value in the low-sugar fruit product is carried out preferably with the aid of a means for adjusting a predetermined pH value in the fruit product by the metering in of an acidity regulator to a value that is higher than the pH value in the fruit educt. For this purpose, the pH value in the fruit educt is then determined preferably by means of the pH meter, for example; and the metering in of an acidity regulator is then monitored as long as the enzymatic and/or fermentative reaction processes are running, so that even after the enzymatic and/or fermentative reaction processes have terminated, it is ensured
that during the reduction of the sugar substances by at least 30% by weight to less than 40% by weight, the pH value is increased from 0.6 to 1.0 pH units; or
that during the reduction of the sugar substances by at least 40% by weight to less than 50% by weight, the pH value is increased from 0.7 to 1.1 pH units; or
that during the reduction of the sugar substances by at least 50% by weight to less than 65% by weight, the pH value is increased from 0.8 to 1.2 pH units; or
that during the reduction of the sugar substances by at least 65% by weight to less than 80% by weight, the pH value is increased from 0.9 to 1.3 pH units; or
that during the reduction of the sugar substances by at least 80% by weight, the pH value is increased from 1.0 to 1.4 pH units;
   wherein the aforementioned pH values may also turn out to be higher or lower even by up to 0.1 or up to 0.2 pH units; and/or
   wherein, in the case of fermentatively formed sugar alcohols having a % by weight fraction of up to 3.0% by weight, the increase in the pH value with the simultaneous reduction of the sugar substances may turn out to be less by up to 0.3 pH units, as compared to a purely enzymatic process, wherein preferably both values correlate to each other, in particular, linearly.

### AP5: Fruit Product Example

The study of the whole process was conducted below on the example of a NFC pineapple juice. In a first step in a reactor, said NFC pineapple juice was treated with the enzymes glucose oxidase, catalase, and invertase, and the enzymatic reaction process was started with adjustment and closed-loop control of an oxygen content of 30% by means of a solenoid valve and computer control.

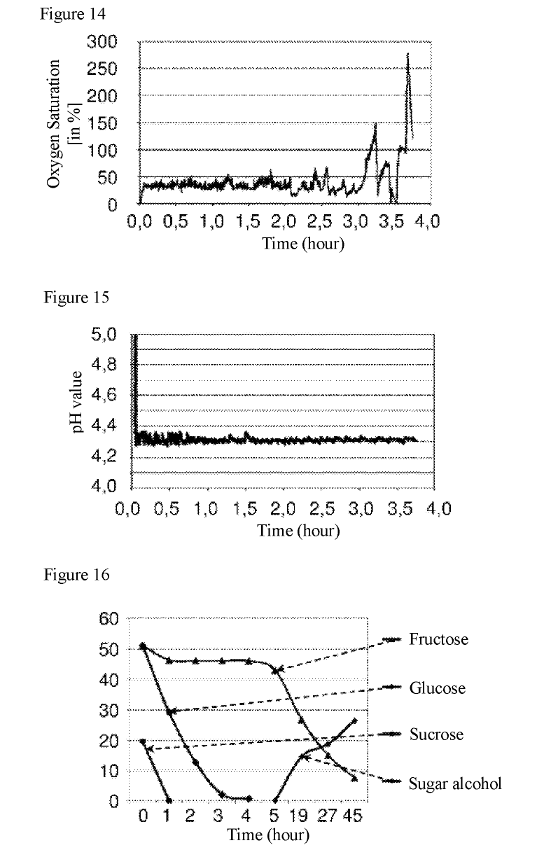

FIG. 14 shows the oxygen saturation in the course of the enzymatic degradation of the sugar substances sucrose and glucose in the NFC pineapple juice. It can be seen that the closed-loop control works very well in the first 3 hours. The oxygen content did not increase again until all of the glucose in the pineapple juice had been completely broken down.

During the enzymatic process step, even the pH value was adjusted as desired to a higher pH value than that in the fruit educt. After its adjustment to, for example, a pH of 4.3 at the beginning of the process, it was possible to keep the pH value within a window of only 0.5 pH units with the control process.

FIG. 15 shows the pH profile during the enzymatic degradation of the sugar substances sucrose and glucose in the NFC pineapple juice.

Finally, FIG. 16 shows the basic change in the concentration of the sugar substances (sucrose and glucose) during the enzymatic degradation and the formation of sugar alcohol during the fermentative degradation of fructose in an NFC pineapple juice.

This closed-loop control described above enables in a reliable way the rapid enzymatic degradation of the sugar substances sucrose and glucose within just 4 hours in the pineapple juice used.

The use of suitable microorganisms after the fifth hour also made possible an almost complete degradation of the sugar substance fructose to form a sugar substitute within another 40 hours.

Thus, even a combination method can be achieved according to the invention and is able to break down more than 95% of all of the essential sugar substances (sucrose, glucose, and fructose) contained in the juice under mild temperature conditions (between, for example, only 20 to 30 degrees C.) within 45 hours.

Thus, the production of low-sugar fruit products by means of the biotechnological methods presented herein offers an opportunity to enter the market with innovative fruit products having a unique selling point. Currently, there is no fruit product that contains, on the one hand, the healthy natural ingredients contained in comminuted fruit as fruit educts, and at the same time has a very low sugar content and also has an acid-to-sugar ratio that is balanced in terms of the sense of taste.

However, the present invention can be used to obtain, in particular, low-sugar fruit products, such as fruit purées or fruit preparations or fruit powder or whole fruit beverages (smoothies) or fruit juices and/or vegetable juices (regardless of whether bottled undiluted as NFC juice or rediluted as fruit juice from fruit juice concentrate) or comparable fruit beverages that can be characterized as alcohol-free, wherein the pH value in the low-sugar fruit product is adjusted, according to the invention to a predetermined higher value, as compared to the pH value in the fruit educt.

1. Method for the biotechnological reduction of sugar substances in fruit educts for the purpose of obtaining low-sugar fruit products by
enzymatic and/or fermentative reaction processes
characterized by
a closed-loop control process, by means of which the pH value in the low sugar fruit product is adjusted to a predetermined higher value, as compared to the pH value in the fruit educt, in such a way
that during the reduction of the sugar substances by at least 30% by weight to less than 40% by weight, the pH value is increased between 0.6 and 1.0 pH units; or
that during the reduction of the sugar substances by at least 40% by weight to less than 50% by weight, the pH value is increased between 0.7 and 1.1 pH units; or
that during the reduction of the sugar substances by at least 50% by weight to less than 65% by weight, the pH value is increased between 0.8 and 1.2 pH units; or
that during the reduction of the sugar substances by at least 65% by weight to less than 80% by weight, the pH value is increased between 0.9 and 1.3 pH units; or
that during the reduction of the sugar substances by at least 80% by weight, the pH value is increased between 1.0 and 1.4 pH units;
wherein the aforementioned pH values may also turn out to be higher or lower by up to 0.1 or up to 0.2 pH units; and/or
wherein, in the case of fermentatively formed sugar alcohols having a % by weight fraction of up to 3.0% by weight, the increase in the pH value with the simultaneous reduction of the sugar substances may turn out to be less by up to 0.3 pH units, as compared to a purely enzymatic process.

2. Method, as claimed in claim 1, characterized in that in the case of fermentatively formed sugar alcohols, the resulting low pH value correlates linearly to the % by weight fraction of the sugar alcohols in such a way that, for example,
at 1.0% by weight of fermentatively formed sugar alcohols, the pH value increase turns out to be less by 0.1 pH units, and
at 2.0% by weight of fermentatively formed sugar alcohols, the pH value increase turns out to be less by 0.2 pH units, and
at 3.0% by weight of fermentatively formed sugar alcohols, the pH value increase turns out to be less by 0.3 pH units.

3. Method, as claimed in claim 1, characterized by an
enzymatic conversion of sucrose into glucose and fructose by means of invertase; and/or
enzymatic conversion of fructose into glucose by means of glucose isomerase.

4. Method, as claimed in claim 1, characterized by an
enzymatic degradation of glucose to form gluconic acid and hydrogen peroxide by means of glucose oxidase
with simultaneous use of catalase to convert the resulting hydrogen peroxide into water and oxygen.

5. Method, as claimed in claim 4, characterized in that during the enzymatic reaction processes by means of glucose oxidase and catalase, the required oxygen is supplied, wherein the oxygen supply is adjusted preferably to saturations between 5% and 60%, in particular, between 10% and 40%, even more preferably between 30% and less than 40%.

6. Method, as claimed in claim 5, characterized in that the oxygen is blown uniformly into a device for carrying out the method.

7. Method, as claimed in claim 1, characterized by a
fermentative degradation of fructose and/or glucose to form sweetening sugar alcohols by means of special microorganisms, such as Leuconostoc mesenteroides, Monitiella tomentosa, and Candida magnoliae,
under preferably aerobic conditions.

8. Method, as claimed in claim 1, characterized by a
fermentative degradation of fructose and/or glucose to form sweetening sugar alcohols by means of special microorganisms, such as Leuconostoc mesenteroides, Monitiella tomentosa, and Candida magnoliae,
under preferably anaerobic conditions.

9. Method, as claimed in claim 7, characterized in that such microorganisms are used that grow in the fruit educt and in the presence of the fruit's own bactericides and, in so doing, form preferably sweetening sugar alcohols, such as erythritol.

10. Method, as claimed in claim 8, characterized in that for anaerobic fermentation before and/or during the use of anaerobic microorganisms, the removal of oxygen is carried out completely enzymatically by means of glucose oxidase and catalase reactions.

11. Method, as claimed in claim 1, characterized in that the adjustment to a higher pH value is carried out, preferably in an automated manner, during the reaction processes.

12. Method, as claimed in claim 11, characterized in that the adjustment to a higher pH value is carried out by adding tasteless salts and/or salt suspensions, such as, in particular, magnesium oxide and/or magnesium oxide suspension.

13. Device for carrying out the method, as claimed in claim 1, characterized in that at least:
means for adjusting a pH value by metering in an acidity regulator to a higher value, as compared to the pH value in the fruit educt; and/or
means for the uniform introduction of oxygen up to a content that is compatible with the sensitive secondary ingredients in the fruit educt,
are provided in this device.

14. Device, as claimed in claim 13, characterized in that it is designed
so as to be closed
and/or
to work at room temperature.

15. Low-sugar fruit products, obtained by a method, as claimed in claim 1, such as fruit purées or fruit preparations or fruit powder or whole fruit beverages (smoothies) or fruit juices and/or vegetable juices or comparable fruit beverages that can be characterized as alcohol free.

16. Method, as claimed in claim 8, characterized in that such microorganisms are used that grow in the fruit educt and in the presence of the fruit's own bactericides and, in so doing, form preferably sweetening sugar alcohols, such as erythritol.
